(19) United States
(12) Patent Application Publication
(10) Pub. No.: US 2018/0354469 A1
(43) Pub. Date: Dec. 13, 2018

(54) CLEANING VEHICLE SENSORS

(71) Applicant: Ford Global Technologies, LLC, Dearborn, MI (US)

(72) Inventor: Venkatesh Krishnan, Canton, MI (US)

(73) Assignee: Ford Global Technologies, LLC, Dearborn, MI (US)

(21) Appl. No.: 15/617,950

(22) Filed: Jun. 8, 2017

(51) Int. Cl. B60S 1/56; B08B 5/02; B08B 3/02; B08B 3/10; B08B 13/00

(52) U.S. Cl. CPC B60S 1/56; B08B 5/02; B08B 13/00; B08B 3/10; B08B 3/02

(57) ABSTRACT

A computer that includes a processor and memory storing instructions executable by the processor. The computer may be programmed to: determine debris on a sensor of a vehicle; determine an absence of an ongoing execution of a collision avoidance instruction; and based on the determinations, apply a fluid to the sensor.

### BACKGROUND

Cleaning a vehicle exterior may occur in a variety of ways. Users of the vehicle may hand-wash the vehicle at home or power-wash the vehicle at a so-called do-it-yourself station. Or the vehicle may be driven through a so-called automated car wash facility. For example, in the automated car wash, a machine having a nozzle is located proximate to the vehicle; thereafter, a soap and water mixture may be applied to the vehicle exterior, and a series of brushes on the machine may remove dirt and debris. The machine further may rinse and blow-dry the vehicle.

### BRIEF DESCRIPTION OF THE DRAWINGS

FIG. 1 is a schematic view of an autonomous driving system for a vehicle that includes a sensor cleaning system.

FIG. 2 is a perspective view of an exemplary sensor that can be cleaned using the sensor cleaning system.

FIG. 3 is an exemplary schematic view of the sensor cleaning system that includes a computer coupled to a plurality of pumps and sensors.

FIG. 4 is a schematic view of fluid delivery system in the vehicle which may be controlled using the computer of the sensor cleaning system.

FIG. 5 is a flow diagram illustrating an exemplary process of using the sensor cleaning system.

FIG. 6 is a side view of another exemplary sensor that can be cleaned using the sensor cleaning system.

### DETAILED DESCRIPTION

According to an illustrative example, an autonomous driving system is described that includes a sensor cleaning system for one or more vehicle sensors. In one example, the sensor cleaning system includes a computer programmed to: determine debris on a sensor of a vehicle, determine an absence of an ongoing execution of a collision avoidance instruction, and based on the determinations, apply a fluid to the sensor.

According to the at least one example set forth above, the computer further is programmed to apply the fluid to a window of the sensor, wherein the window comprises a cover, a lens, or a combination thereof.

According to the at least one example set forth above, the sensor is a camera or light detection and ranging (LIDAR) device that provides imaging data to an autonomous driving system in the vehicle.

According to the at least one example set forth above, the fluid is one of a gas or a liquid.

According to the at least one example set forth above, the computer further is programmed to apply the fluid during a predetermined time interval associated with the determined absence.

According to the at least one example set forth above, the predetermined time interval is less than three seconds.

According to the at least one example set forth above, the computer further is programmed to apply a first fluid to the sensor based on the determination of the debris, wherein, when the first fluid does not remove the debris, the computer further is programmed to apply a second fluid to the sensor based on the determination of the debris on the sensor and based on the determined absence.

According to the at least one example set forth above, the first fluid is compressed air, wherein the second fluid is a cleaning solution.

According to the at least one example set forth above, the computer further is programmed to: determine second debris on a second sensor; and determine to apply the fluid the first and second sensors sequentially based on determining that the first and second sensors are within a common zone of the vehicle.

According to the at least one example set forth above, the computer further is programmed to: determine that a collision avoidance instruction will not be initiated within a predetermined time interval; and based on this determination and the determination of the debris, then apply the fluid to the sensor during the interval.

According to the at least one example set forth above, the computer further is programmed to: determine that a rain rate parameter is less than or equal to a threshold; and based on this determination, determine to apply a first fluid to the sensor.

According to the at least one example set forth above, the computer further is programmed to: determine whether the debris has been removed; and when it has not been removed, then determine to apply a second fluid to the sensor.

A system may include: the computer according to the at least one example set forth above; and at least one pump, wherein the computer further is programmed to control the at least one pump to deliver the fluid to the sensor.

According to the at least one system example set forth above, the system may include the at least one pump may have a plurality of ports, wherein the computer further is programmed to selectively actuate the plurality of ports to control delivery of the fluid to a plurality of sensors.

According to the at least one system example set forth above, the system further may include at least one sensor coupled to the computer that provides an indication of temperature, rain rate, or both.

According to another illustrative example, a method may include: determining debris on a first sensor of a vehicle; determining an absence of an ongoing execution of a collision avoidance instruction; and based on the determinations, applying a fluid to the first sensor.

According to the at least one method example set forth above, the first sensor is a camera or light detection and ranging (LIDAR) device that provides imaging data to an autonomous driving system in the vehicle.

According to the at least one method example set forth above, the method further may include: applying a first fluid to the first sensor based on the determination of the debris; determining that the first fluid did not remove the debris; then applying a second fluid to the first sensor based both on the determination that the first fluid did not remove the debris and the determined absence

According to the at least one method example set forth above, the first fluid is compressed air, wherein the second fluid is a cleaning solution

According to the at least one method example set forth above, the method further may include: determining second debris on a second sensor; and applying the fluid the first and second sensors sequentially based on determining that the first and second sensors are within a common zone of the vehicle

According to the at least one example, a computer is disclosed that is programmed to execute any combination of the method examples set forth above.

According to the at least one example, a computer program product is disclosed that includes a computer readable medium storing instructions executable by a computer processor, wherein the instructions include any combination of the instruction examples set forth above.

According to the at least one example, a computer program product is disclosed that includes a computer readable medium that stores instructions executable by a computer processor, wherein the instructions include any combination of the method examples set forth above.

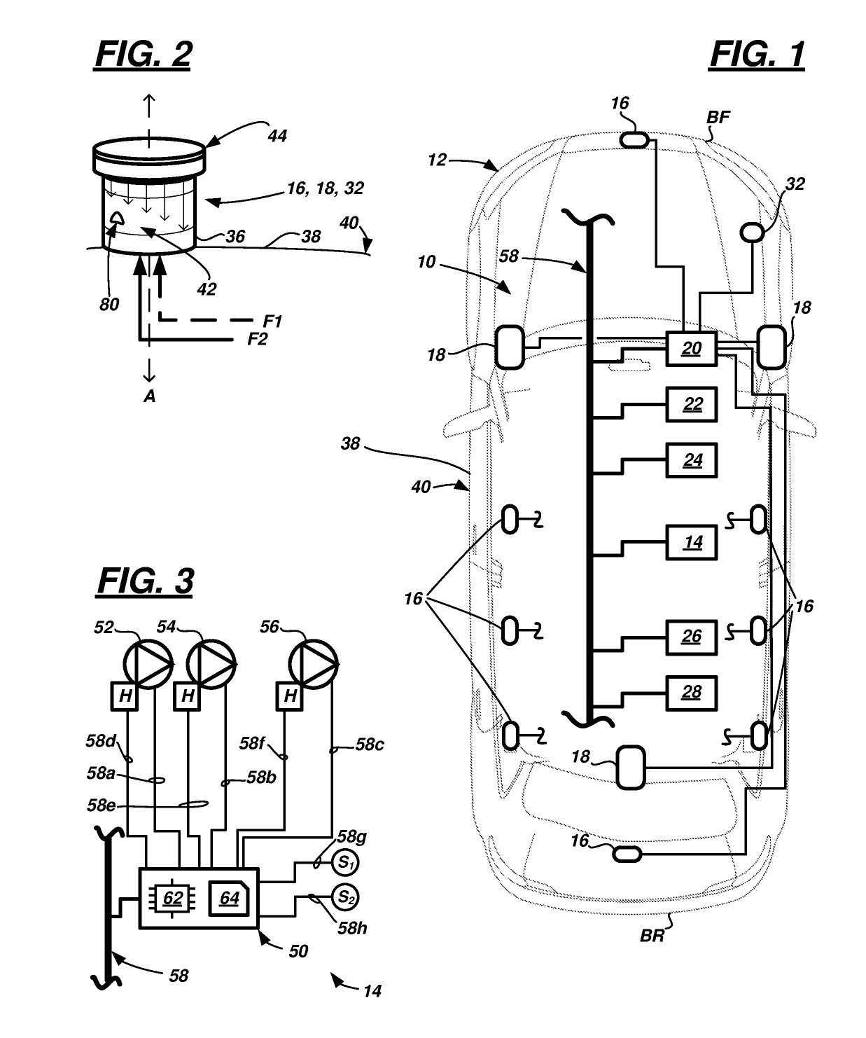

Now turning to the figures, wherein like numerals indicate like parts throughout the several views, there is shown an autonomous driving system 10 for a vehicle 12 that includes an onboard sensor cleaning system 14 for cleaning a plurality of vehicle sensors 16, 18, wherein the sensors 16, 18 receive sensor input data at a respective detector via a window thereof. In the non-limiting illustration of FIG. 1, sensors 16 are cameras and sensors 18 are LIDAR devices—each of which may be used during operation of the vehicle 12 in an autonomous driving mode (e.g., providing imaging data used to navigate vehicle 12). As will be described more below, while operating the vehicle 12, the cleaning system 14 can apply a fluid to the window of at least one of sensors 16, 18. According to one example, the fluid may be a liquid cleaning solution stored in an onboard reservoir. Cleaning the sensors 16, 18 may be desirable as the quality of imaging data received thereby may be based at least partially on the cleanliness of their respective windows. Depending on the environment and the number of sensors 16, 18 of vehicle 12, the cleaning solution could be consumed relatively rapidly. In order to conserve fluid, sensor cleaning system 14 may determine which sensors 16, 18 have debris on their respective windows, what type of fluid to apply, how much fluid to apply, and when to apply it. At least one non-limiting example of a process of cleaning the sensors 16, 18 will be described below.

Referring to FIG. 1, the vehicle 12 is shown as a passenger car; however, vehicle 12 could also be a truck, sports utility vehicle (SUV), recreational vehicle, bus, train, marine vessel, aircraft, or the like that includes the sensor cleaning system 14. According to at least one example, the autonomous driving system 10 of vehicle 12 may be operated in any one of a number of autonomous modes. For example, vehicle 12 may operate in a fully autonomous mode (e.g., a level 5), as defined by the Society of Automotive Engineers (SAE) (which has defined operation at levels 0-5), as explained more below. In other examples, vehicle may operate at levels 0-2, wherein a human driver monitors or controls the majority of the driving tasks, often with no help from the vehicle 12. For instance, at level 0 (“no automation”), a human driver is responsible for all vehicle operations. At level 1 (“driver assistance”), the vehicle 12 sometimes assists with steering, acceleration, or braking, but the driver is still responsible for the vast majority of the vehicle control. At level 2 (“partial automation”), the vehicle 12 can control steering, acceleration, and braking under certain circumstances without human interaction. In other examples, vehicle may operate at levels 3-4, wherein the vehicle 12 assumes more driving-related tasks. For instance, at level 3 (“conditional automation”), the vehicle 12 can handle steering, acceleration, and braking under certain circumstances, as well as monitoring of the driving environment. Level 3 may require the driver to intervene occasionally, however. At level 4 (“high automation”), the vehicle 12 can handle the same tasks as at level 3 but without relying on the driver to intervene in certain driving modes. And in at least one example, vehicle 12 operates at level 5 (“full automation”), wherein the vehicle 12 can handle all tasks without any driver intervention.

In order to operate in the fully autonomous mode, autonomous driving system 10 may utilize a sensor suite 20, a steering system 22, a braking system 24, a powertrain system 26, a collision avoidance system 28, the sensor cleaning system 14 described above, as well as a number of other integrated systems which are arranged, programmed, and otherwise adapted to replace the decision-making capacities, experience, and interactions of a human driver. As described more below, each of these systems 14, 20-28 may include one or more interactive computing devices (e.g., each system may comprise one or more computing devices which execute programming instructions which enable the systems 14, 20-28 collectively to operate the vehicle 12 in the fully autonomous mode). As described below, the sensor suite 20 may receive imaging data from multiple sensors, and the driving system 10 may use this imaging data to navigate and control movement of vehicle 12.

The sensor suite 20 may comprise one or more sensors 16, 18, 32, one or image processing computers (not shown) coupled to the sensors 16-18, 32, and one or more sets of instructions (e.g., such as software, firmware, and the like) executable by the computers. Among other things, the sensor suite 20 may be programmed so that the imaging data (derived from sensors 16-18, 32 and) received by other vehicle systems 22-28 facilitates autonomous navigation and driving of vehicle 12. Non-limiting examples of autonomous driving sensors include: the one or more day cameras 16 (e.g., complementary metal oxide semiconductor (CMOS) devices, charge-coupled devices (CCDs), image intensifiers (so-called i-squared devices), etc.) (e.g., eight are shown for illustrative purposes); the one or more laser identification detection and ranging (LIDAR) devices 18 (e.g., three are shown for illustrative purposes); radio detection and ranging (RADAR) devices (not shown); a navigation device (e.g., a GPS (global positioning system) sensor or a GLONASS (global navigation satellite system) sensor) (none are shown); one or more accelerometers (none are shown); one or more gyroscopes (none are shown); and one or more laser range finders 32 (LRFs) (e.g., one is shown for illustrative purposes), just to name a few examples. Thus, some of sensors 16-18, 32 may be so-called passive sensors (e.g., CMOS or CCD cameras)—which receive imaging data without a sensor output—and some of sensors 16-18, 32 may be so-called active sensors (e.g., LIDAR devices, LRFs, etc.)—which receive imaging data in response to a sensor output (e.g., such as a visible or non-visible light emission from the respective sensor).

FIG. 2 illustrates an example of sensor 16, 18, or 32. The sensor 16, 18, or 32 may comprise a housing 36 coupled to a vehicle body panel 38 and/or vehicle frame (not shown)—e.g., extending outwardly of a vehicle surface 40. The sensor 16, 18, or 32 may include a detector (e.g., having light energy- and/or heat energy-sensitive surface(s)) (not shown) which is located within the housing 36. Further, the housing 36 may comprise a window 42 adapted to permit light, energy, and the like to pass therethrough from the vehicle's environment and be received at the detector. Consequently, a focal axis of the detector may be aligned with window 42. Other sensor examples also exist. For example, FIG. 6 illustrates another non-limiting example of a sensor 16′, 18′, 32′ (side view) that can be cleaned using the sensor cleaning system 14—e.g., having, among other things, a body 36′ extending from a surface 40′ and a window 42′ located on the body 36′. Still other arrangements exist.

In the illustrated example of FIG. 2, the housing 36 is cylindrical, and the window 42 is an arcuately-shaped cover comprised of a material having a relatively high transmissivity (e.g., so that a relatively large amount of light passes through the material in relation to an amount of light incident on the material—e.g., a relatively little amount of the light is reflected or absorbed by the window). The window 42 shown in FIG. 2 at least partially may wrap around the housing 36. This may be particularly useful to scanning devices such as cameras 16, LIDAR devices 18, or LRFs 32 which may scan 0-360 degrees around an axis A of rotation. In some examples, the detector within housing 36 may be fixed, or alternatively, it may be mounted on a gimbal or the like so that it may be rotated within the housing 36.

In at least one example of sensor 16, 18, 32, a pressurized first fluid F1, a pressurized second fluid F2, or a combination thereof may be received through the housing 36 (e.g., from one or more pumps—discussed below) and expelled downwardly from a circular nozzle 44 located atop the respective sensor to clean the window 42 thereof. According to one non-limiting example, first fluid F1 is a gas (e.g., compressed air), and second fluid F2 is a liquid (e.g., a cleaning solution such as water, windshield washer fluid, or the like).

Of course, FIG. 2 is merely an example. For instance, the housing 36 of at least some camera and LRF implementations 16, 32 may be rectangular having a generally planar window 42 or the like. Further, examples of sensors 16, 18, 32 exist wherein the housing is located within the body panel 38 of the vehicle 12—e.g., such that the window 42 is generally parallel to the surface 40. Still other examples exist. Regardless of the shape, size, and location of the respective sensor, a nozzle 44 (e.g., circular or otherwise) may be positioned and oriented to provide the first or second fluid F1, F2 to the window 42—as controlled by the cleaning system 14, as described more below.

In active-sensing devices, a laser or emitter (not shown) also may be aligned with the detector and window 42 so that light, energy, etc. may be transmitted through the window 42 and reflections of said light, energy, etc. similarly may be received therethrough at the detector. As used herein, the window 42 can be any suitable lens (or series of lenses), a transmissive cover, or a combination thereof. Further, not all sensors 16-18, 32 require a window 42; thus, examples of sensors 16-18, 32 without a window 42 also may exist.

The steering system 22 may include any suitable steering components (e.g., electrical parts, mechanical parts, electro-mechanical parts, linkages, or the like) and/or one or more computing devices coupled to any combination of the steering components, wherein the computing devices control the movement of the steering components to control the direction of moving vehicle 12. Other aspects of the steering system 22, its assembly and construction, and the techniques for controlling it will be appreciated by skilled artisans.

The braking system 24 may include any suitable braking components used by the system 24 to slow or stop vehicle movement. In at least one example, the braking system 24 includes a computer-controlled anti-lock braking system that enables the vehicle tires (not shown) to maintain tractive contact with a roadway surface while a computing device instructs the application of a braking input which would otherwise cause the wheels to lock up and skid relative to the roadway. Other aspects of the braking system 24, its assembly and construction, and the techniques for controlling it will be appreciated by skilled artisans.

The powertrain system 26 may comprise one or more vehicle motors (not shown) coupled to a transmission assembly (not shown), one or more computing devices to control the motor and/or transmission assembly speeds, and the like. Non-limiting examples of the motor include a conventional combustion engine, an electric motor, a hybrid-electric motor, etc. Using a plurality of gear ratios, the transmission may couple power between the motor and a drive axle, ultimately providing rotational energy to the vehicle wheel(s). Other aspects of the powertrain system 26, its assembly and construction, and the techniques for controlling it will be appreciated by skilled artisans.

The collision avoidance system 28 may comprise one or more computing devices that provide and/or receive data and/or instructions to the steering system 22, the braking system 24, the powertrain system 26, or the like, wherein the instructions are associated with a potential or imminent collision event. In at least some examples, the collision avoidance system 28 may be at least partially integrated within the steering, braking, and/or powertrain systems 22-26. In other examples, the collision avoidance system 28 may be a physically and logically separate computing system of vehicle 12. Regardless of the arrangement, non-limiting examples of collision avoidance instructions provided by or received by the system 28 include: apply vehicle brakes to slow the vehicle 12 in order to avoid a collision with another object or in order to follow a determined or predetermined path (e.g., along a roadway); control vehicle steering and/or braking system 22, 24 in response to a determination that the vehicle tires are skidding or sliding with respect to a roadway; provide a vehicle steering instruction to control the direction of vehicle 12 (e.g., to maintain the vehicle within roadway lane markers or to avoid a collision with another object (e.g., a person, vehicle, infrastructure, etc.)); provide an instruction to control the speed of the vehicle motor and/or vehicle transmission (e.g., to slow or speed up movement of the vehicle 12 to avoid a collision or other dangerous circumstance); provide an instruction to deploy vehicle airbags just prior to a collision event; provide a combination of such instructions; and the like. Still other examples exist. As described more below, the autonomous driving system 10 first may determine whether one of these exemplary instructions has been initiated before proceeding to clean one of the sensors 16, 18, 32.

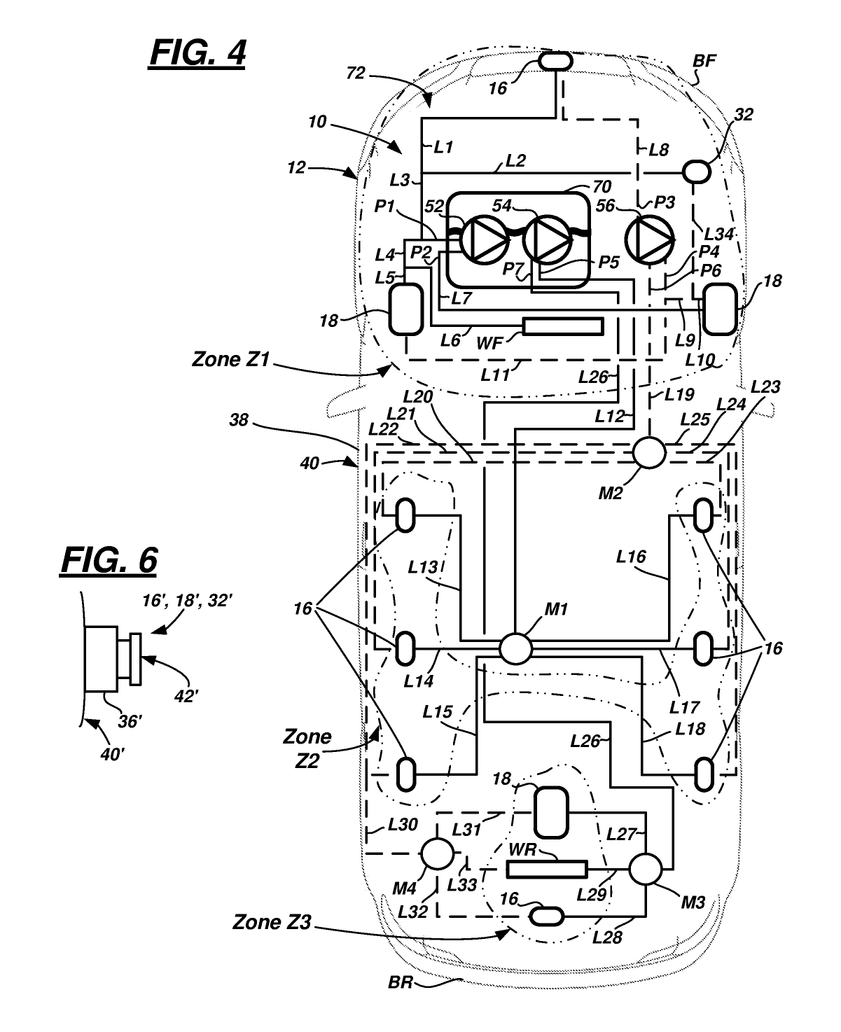

As described above, the autonomous driving system 10 of vehicle 12 also may comprise the sensor cleaning system 14—e.g., for cleaning debris from the sensors 16, 18, 32 of sensor suite 20. Autonomous vehicle operation may rely, at least in part, on the cleanliness of the sensors 16, 18, 32 by which the system 14 obtains autonomous driving information. FIGS. 3-4 illustrate one such exemplary system 14.

FIG. 3 illustrates that cleaning system 14 may comprise, among other things: a computer 50, one or more vehicle sensors S1, S2, and one or more pumps 52, 54, 56. The computer 50 may be coupled to a suitable wired or wireless network connection 58 that enables electronic communication between the sensor cleaning system 14 (e.g., or more specifically, computer 50), sensor suite 20, steering system 22, braking system 24, powertrain system 26, collision avoidance system 28, and/or the like. In at least one example, the connection 58 includes one or more of a controller area network (CAN) bus, Ethernet, Local Interconnect Network (LIN), a fiber optic connection., etc. Other examples also exist. For example, alternatively or in combination with e.g., a CAN bus, connection 58 could comprise one or more discrete wired or wireless connections—e.g., such as connections 58g, 58h shown coupling sensors S1, S2 to computer 50.

Computer 50 may be a single computer (or multiple computing devices—e.g., as described above, computer 50 may be shared physically and/or logically with other vehicle systems and/or subsystems). Computer 50 may comprise a processing circuit or processor 62 coupled to memory 64. For example, processor 62 can be any type of device capable of processing electronic instructions, non-limiting examples including a microprocessor, a microcontroller or controller, an application specific integrated circuit (ASIC), etc.—just to name a few. In general, computer 50 may be programmed to execute digitally-stored instructions, which may be stored in memory 64, which enable the computer 50, among other things: to determine debris on a sensor 16, 18, 32 of the vehicle 12, determine an absence of an execution of a collision avoidance instruction, and based on the determinations, apply a fluid to the sensor 16, 18, 32. As used herein, debris should be broadly construed to include dirt, dust, sand, mud, pollen, insect or animal body parts or feces, pieces of rubbish or waste, ice, snow, food, other like contaminants, etc.

Memory 64 may include any non-transitory computer usable or readable medium, which may include one or more storage devices or articles. Exemplary non-transitory computer usable storage devices include conventional computer system RAM (random access memory), ROM (read only memory), EPROM (erasable, programmable ROM), EEPROM (electrically erasable, programmable ROM), as well as any other volatile or non-volatile media. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read. As discussed above, memory 64 may store one or more computer program products which may be embodied as software, firmware, or the like.

Sensors S1, S2 are shown coupled electrically to computer 50 to provide sensor data thereto (e.g., temperature data, atmospheric pressure data, humidity data, rain data, etc.). Also, any suitable quantity of sensors may be used. In addition, multiple S1-type sensors could be used, multiple S2-type sensors could be used, a combination thereof could be used, and/or additional types of sensors could also be used.

Sensors S1, S2 may be located in any suitable vehicle location; e.g., they may be located at least partially outside of a vehicle cabin so that they can measure environmental factors also experienced by sensors 16, 18, 32. According to one non-limiting example, sensor S1 measures temperature data, and sensor S2 measures rain data. For example, sensor S1 may be located in a vehicle grill or near a vehicle front windshield. And for example, sensor S2 may be located on a windshield (e.g., at a base of a mount for a rearview mirror, as appreciated by skilled artisans. Using sensors S1, S2, computer 50 may determine whether it is precipitating, what type of precipitation is occurring (e.g., rain, snow, sleet, hail, etc.), a rain rate (e.g., rain per unit time against a corresponding windshield), etc. As discussed more below, computer 50 may not use a liquid-type fluid to clean the sensors 16, 18, 32 when the rain rate exceeds a threshold, and/or computer 50 may warm the fluid being applied to the sensors 16, 18, 32 when the temperature data indicates a temperature less than a predetermined threshold (e.g., less than 5° C.). Other examples and arrangements also exist.

FIG. 3 schematically illustrates that computer 50 may control selective actuation of pumps 52-56. For example, via network connections 58a, 58b, 58c, computer 50 selectively may toggle ON and OFF pumps 52-56. Or computer 50 selectively may control an electrical signal to the pumps via connections 58a-58c which controls a speed or other aspect of the pumps 52-56 (e.g., controlling variable-speeds on pumps 52-56 according to a voltage or current provided via connections 58a-58c). Other pump control examples are also possible.

As shown in FIG. 3, each of pumps 52-56 may comprise a heater (H), which selectively may be actuatable by computer via connections 58d, 58e, 58f, respectively. In this manner, fluid moved through pumps 52-56 selectively may be warmed before it is expelled from the respective nozzles 44. As will be explained more below, fluid F1 (e.g., a gas) may be warmed to melt snow or ice accumulation on a sensor window 42. Similarly, when the sensor Si indicates that the ambient temperature is less than a threshold (e.g., less than 5° C.), fluid F2 (e.g., a liquid) could be warmed to melt snow or ice accumulations and/or could be warmed to avoid the fluid F2 from freezing to the respective sensor 16, 18, 32. While connections 58a-58f are shown as discrete connections, other examples exist—e.g., including examples wherein the instructions sent from computer 50 thereto are communicated via a bus, via a wireless link, or the like. Further, the heaters H are not required to be located at the pumps 52-56. For example, one or more the heaters H may be located downstream of the pumps 52-56—e.g., closer to the respective nozzles 44.

FIG. 4 schematically illustrates that pumps 52, 54 may be located in a reservoir 70 (e.g., for storing second fluid F2) while pump 56—that may provide fluid F1—may not require such a reservoir. In the discussion that follows, first fluid F1 (provided by pump 56) will be described as compressed air, and second fluid F2 (provided by pumps 52-54) will be described as a liquid (e.g., a cleaning solution). This is merely one example. Further, a network of passages 72 (L1, L2, L3, . . . , L34) are described that facilitate fluid communication between the pumps 52-56 and sensors 16, 18, 32; this network 72 is also merely an example (other arrangements are possible).

In the illustrated example, sensors 16, 18, 32 are dispersed among vehicle zones Z1, Z2, Z3. Zone Z1 defines a vehicle forward region—e.g., including sensors located between a top of a vehicle frontward-facing windshield (not shown) and a front vehicle bumper BF. Zone Z2 defines a middle region—e.g., including sensors located between zone Z1 and a top of a vehicle rearward-facing windshield (not shown). And zone Z3 defines a rearward region—e.g., including sensors located between zone Z2 and a rear vehicle bumper BR.

More particularly, in zone Z1, pump 52, via port P1, may be in fluid communication: with a camera 16 via passages L1, L3; with LRF 32 via passages L2, L3; with a port side LIDAR 18 via passages L4, L5; and with a nozzle WF for the frontward-facing windshield via passages L4, L6. Also in zone Z1, pump 52, via port P2, may be in fluid communication with a starboard side LIDAR 18 via passage L7.

Also, in zone Z1, pump 56, via port P3, may be in fluid communication camera 16 via passage L8. Similarly, in zone Z1, pump 56, via port P4, may be in fluid communication: with starboard side LIDAR 18 via passages L9, L10; with port side LIDAR 18 via passage L11; and with LRF 32 via passages L9, L34.

Turning more particularly to zone Z2, pump 54, via port P5, may be in fluid communication with a manifold M1 via passage L12. Three port side cameras 16 may be in fluid communication with manifold M1 via passages L13, L14, L15, respectively. Similarly, three starboard side cameras 16 may be in fluid communication with manifold M1 via passages L16, L17, L18, respectively.

Also, in zone Z2, pump 56, via port P6, may be in fluid communication with a manifold M2 via passage L19. The three port side cameras 16 may be in fluid communication with manifold M2 via passages L20, L21, L22, respectively. Similarly, the three starboard side cameras 16 may be in fluid communication with manifold M2 via passages L23, L24, L25, respectively.

Turning more particularly zone Z3, pump 54, via port P7, may be in fluid communication with a manifold M3 via passage L26. And a LIDAR device 18, a camera 16, and a nozzle WR (for cleaning the rearward-facing windshield) may be in fluid communication with manifold M3 via passages L27, L28, and L29, respectively.

Also, in zone Z3, pump 56, via port P6 may be in fluid communication with a manifold M4 via passages L19, L22, L30 and manifold M2. And the LIDAR device 18, the camera 16, and nozzle WR (in zone Z3) may be in fluid communication with manifold M4 via passages L31, L32, and L33, respectively.

Thus, in operation, computer 50 may control pump 52 to provide second fluid F2 (via port P1) to the front camera 16, port side LIDAR device 18, LRF 32, and front windshield nozzle WF. Or selectively, computer 50 may control pump 52 to provide second fluid F2 (via port P2) to starboard side LIDAR device 18. Of course, other arrangements are also possible-e.g., wherein pump 52 has dedicated and selectively-actuatable ports for all sensors 16, 18, 32 within zone Z1.

Similarly, computer 50 selectively may control port P5 of pump 54 to provide fluid F2 to zone Z2 or control port P7 to provide fluid F2 to zone Z3. Still further, computer 50 similarly may control pump 56 by selective control of ports P3, P4, P6. For example, selective control of ports P3 or P4 may control delivery of first fluid F1 to zones Z1 and Z2, and selective control of port P6 may control delivery of first fluid F1 to zones Z2 and Z3. Again, other arrangements are also possible—e.g., wherein pump 54 and/or pump 56 have dedicated and selectively-actuatable ports for all sensors 16, 18, 32 within the respective zones. Thus, FIG. 4 is merely one example.

As will be explained in greater detail below, cleaning system 14 may be used to clean one sensor (e.g., 16, 18, 32) per zone at any given time. Thus, if computer 50 determines that both LIDAR devices 18 in zone Z1 have debris requiring removal (e.g., using a fluid F2), computer 50 may determine a priority (e.g., which one is dirtier) and/or may determine to clean the LIDAR devices 18 sequentially (e.g., rather than concurrently). For example, if computer 50 determines that autonomous driving system 10 is operating in a fully autonomous mode, then computer 50 may determine to clean the sensors sequentially. However, in other circumstances (e.g., wherein the vehicle 12 is parked or operating in a different autonomous mode), computer 50 may determine clean the sensors 16, 18, 32 at least partially concurrently. It should be appreciated that, during cleaning of the devices 18, second fluid F2 (e.g., a liquid) may obscure the field of view of the respective sensor and that imaging data obtained therefrom during this interval may be unsuitable for operating vehicle 12 in the fully autonomous mode. However, by cleaning one sensor at a time (e.g., at least within a given zone), computer 50 may continue to gather imaging data from other sensors within the zone while the selected sensor is cleaned.

Thus, in at least one example, computer 50 may determine to clean concurrently two sensors in different zones. For example, in the fully autonomous mode, computer 50 may clean concurrently port side LIDAR device 18 (zone Z1) and the LIDAR device 18 located in zone Z3. Other at least partially concurrently scenarios also exist.

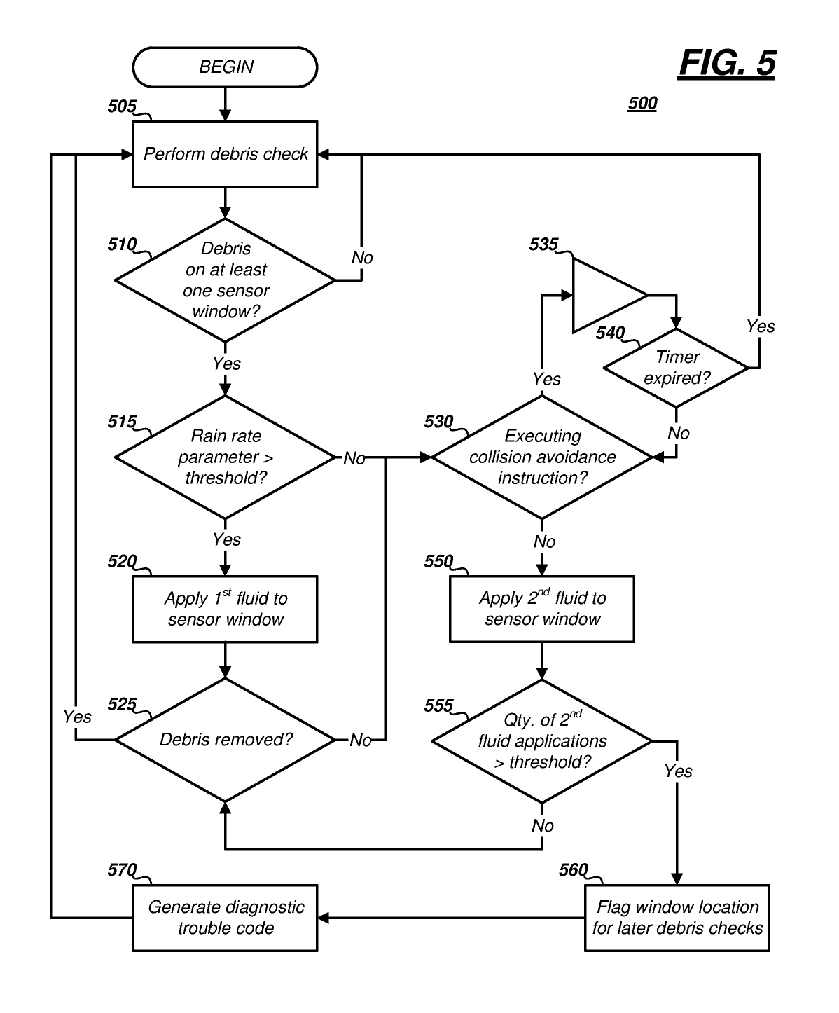

Turning now to FIG. 5, a process of using sensor cleaning system 14 is illustrated which occurs while the vehicle 12 is operating in an autonomous driving mode. In at least the example that follows, vehicle 12 is in the fully autonomous driving mode.

Process begins with block 505 wherein computer 50 may perform a check as to whether a window 42 of one of sensors 16, 18, 32 is contaminated (e.g., having at least some debris thereon which may obscure a respective field of view of its detector). To determine the presence of debris, processor 62 of computer 50 may execute one or more detection algorithms stored in memory 64—e.g., as the sensors 16, 18, 32 receive and process imaging data. These algorithms may include sets of instructions that perform any number of routines, including but not limited to: dividing an image area (e.g., captured by the detector) into a plurality of sub-regions; determining one or more baseline distortion parameters for at least some of the sub-regions, wherein the baseline distortion parameters are associated with sensor optics or other sensor hardware (e.g., non-limiting distortion parameter examples include lateral and/or longitudinal chromatic aberrations, vignetting, and other known distortions); determining whether each respective sub-region exhibits greater distortion than the baseline; and/or flagging the sub-region by storing an identifier associated with the sub-region memory 64. Of course, this algorithm is merely one example; other techniques may be employed by computer 50 during the check. These and other digital imaging processing techniques are known to skilled artisans.

Further, as exemplified in FIGS. 1 and 4, vehicle 12 may have a plurality of sensors 16, 18, 32. Thus, computer 50 may perform the check with respect to all of the sensors 16, 18, 32. This may occur sequentially or at least partially concurrently.

In block 510 (which follows), computer 50 may determine whether there is debris 80 on at least one sensor window 42 (see also FIG. 2). If computer 50 determines the presence of debris 80, process 500 proceeds to block 515. And if computer 50 does not determine the presence of debris, process 500 may loop back and repeat block 505. This may occur repeatedly—e.g., while the vehicle ignition state is ON.

In block 515, the computer 50 may determine whether a rain rate parameter is greater than a predetermined rain rate threshold. For example, during process 500, computer 50 may receive sensor data from sensor S2, determine a rain rate parameter therefrom, and compare that parameter to the threshold. If rain rate parameter is not greater than the threshold, then the process proceeds to block 530 (which will be discussed more below). However, if the computer 50 determines that the rain rate parameter is larger than the threshold, the process proceeds to block 520.

In block 520, based on the determination in block 515, computer 50 applies a first fluid F1 to the respective sensor window 42. Continuing the example above, first fluid F1 may be compressed air or other suitable gas. By expelling compressed air, sensor cleaning system 14 may preserve the finite volume of second fluid F2 onboard vehicle 12 (e.g., in reservoir 70). Thus, the rain rate threshold may correspond to a rain rate which has been empirically or theoretically determined suitable for removing common forms of debris 80 from sensor 16, 18, 32.

In block 525 which follows block 520, computer 50 may determine whether applying the first fluid F1 removed debris 80 from the respective sensor. According to one example, this may include execution of the detection algorithm discussed above (e.g., in block 505). In at least some examples, computer 50 may compare the particular sub-region(s) (of the detector previously-associated with the debris 80) to the previously-determined baseline distortion parameters. If, in block 525, computer 50 determines that debris 80 has been removed, then process 500 may loop back to block 505 and repeat at least a portion of the process. However, if computer 50 determines that debris 80 was not removed, then process 500 may proceed to block 530.

In block 530 (which may follow block 515 or block 525), computer 50 determines whether a collision avoidance instruction is being executed (e.g., an ongoing execution) or will be executed within a predetermined time interval (e.g., within 3 seconds). A few examples of collision avoidance instructions were listed above; however, other examples exist. In the absence of the execution of a collision avoidance instruction (or in the absence of the collision avoidance instruction being initiated within the predetermined time interval), process 500 may proceed to block 550. However, if computer 50 determines that either a collision avoidance instruction is being executed (or may be initiated within the predetermined interval), then process 500 proceeds block 535.

In block 535, computer 50 executes a pause or delay—e.g., waiting a predetermined delay period before applying fluid F2 the respective sensor. In this manner, a previously-executed collision avoidance instruction may be fully carried out, or a collision avoidance instruction which is likely to be executed within the predetermined time interval may be initiated and completed. For the purposes of illustration only, consider the previously-described collision avoidance instruction example wherein computer 50 determines, in the fully autonomous mode, that a vehicle steering instruction was provided to control the direction of vehicle 12 to maintain the vehicle 12 within roadway lane markers. In this example, at the time computer 50 executes block 530, computer 50 (or other aspect of autonomous driving system 10) may determine that the vehicle 12 is drifting within its lane. Hence, no collision avoidance instruction may yet be executed. If the vehicle 12 continues to drift, computer 50 may determine a relatively high likelihood (e.g., more than 50%) that a collision avoidance instruction will be executed since drifting across a vehicle lane marker would trigger such an instruction. In this example, computer 50 may proceed from block 530 to block 535.

In at least one example of block 535, computer 50 sets a timer. In this manner, computer 50 may not indefinitely loop between blocks 530 and 535.

In block 540 which follows, computer 50 determines whether the timer has expired. For example, computer memory 64 may store a timer expiration value. If timer has expired, process 500 may loop back to block 505 and repeat at least a portion of the process 500. This may also permit the computer 50 to re-check whether the debris 80 still remains on the sensor 16, 18, 32. If timer has not expired, process 500 loops back to block 530 and repeats.

Once process 500 proceeds to block 550, computer 50 may apply a second fluid F2 to the sensor window 42. This may occur during the predetermined time interval (or the equivalent thereof, if a collision avoidance instruction was likely to be initiated). Application of fluid F2 may occur for a predetermined cleaning interval—e.g., within 500 milliseconds (ms)—and the predetermined cleaning interval may be a shorter duration than the predetermined time interval. In this manner, any environmental distortion caused by ejecting a liquid on the respective sensor window 42 may be minimally disruptive to the autonomous driving system 10 operating in the fully autonomous driving mode. Further, unlike cleaning the respective sensor with compressed air F1, while the sensor is being cleaned with liquid F2, the sensor may be unable to provide useful or viable imaging data and, within the respective zone, only the imaging data from the other sensors may be used to drive in the fully autonomous mode. To illustrate an example, consider zone Z1. If the port side LIDAR device 18 is being cleaned, the autonomous driving system 10 may be receiving image data only from the camera 16 (near the front of vehicle 12), the starboard side LIDAR device 18, and the LRF 32 during the cleaning interval. Consequently, it may be desirable to minimize the duration of the cleaning interval. Further, as explained above, computer 50 may select one sensor 16, 18, 32 per zone at a time to clean with fluid F2, whereas computer 50 concurrently may clean multiple sensors using fluid F1—e.g., regardless of whether they are in the same zone or a different zone.

According to at least one example of block 550, computer 50 may store a debris location in memory 64. This location may be associated with the sub-regions determined block 550 above. Further, based on the application of fluid F2 and the particular debris 80, computer 50 may increment a counter associated with the debris location. For example, on the first attempt to remove debris 80, the counter value may be one (1). If repeated attempts are made (as discussed below), then the counter may be incremented to two (2), three (3), etc. Following block 550 the process proceeds to the 555.

In block 555, computer 50 determines whether the counter value is larger than a predetermined threshold (e.g., whether the quantity of second fluid F2 applications to remove the particular debris 80 is larger than a threshold (e.g., five fluid F2 applications)). If the counter value is greater than the predetermined threshold, process 500 may proceed to block 560. If it is not, then process computer 50 may loop back to block 525 and repeat at least a portion of process 500. In this manner, the quantity of fluid F2 may be conserved—e.g., inhibiting system 14 from depleting all or too much fluid F2 on debris 80 alone.

In block 560, computer 50 may flag the debris location for later debris checks. For example, once a region of the window 42 is determined to have debris which is not removed after repeated attempts, it may not be desirable to repeat process 500 and attempt to remove the same debris 80 again later using fluids F1 and/or F2. Thus, in block 560, computer 50 flags this region so that it may be ignored during subsequent debris checks (e.g., such as those as discussed in block 505). Following block 560 the process proceeds to block 570.

In block 570, computer 50 may generate a diagnostic trouble code (DTC) or other suitable type of diagnostic indication. Computer 50 may store the DTC in computer memory 64 and ultimately report this DTC to a user of vehicle 12, to authorized service personnel, or the like. Reports to the user may include providing a visible and/or audible alert to the user within the cabin, via a mobile device, or the like. Reports to authorized service personnel may enable the personnel to locate and remove the debris 80. Still further, such reports may assist service personnel in identifying that the purported debris is instead damage (e.g., a chip or crack in the window 42).

Other examples of process 500 are also possible. According to one non-limiting example, using sensor S1, computer 50 may determine an ambient vehicle temperature (e.g., an exterior vehicle temperature). If the sensor S1 indicates that the temperature is less than a threshold (e.g., 5° C.), then in process 500, computer 50 may warm the fluids F1 and/or F2 delivered to the respective sensor 16, 18, 32.

According to another example, process 500 may apply the first fluid F1 to sensors 16, 18, 32 regardless of the rain rate parameter. Thereafter, the respective sensor may be checked again (e.g., in block 525), and if the debris 80 is not removed from the respective sensor, then the second fluid F2 may be applied (e.g., provided an absence of the execution of a collision avoidance instruction, or a low likelihood that a collision avoidance instruction will be initiated within the predetermined time interval).

Thus, there has been described an autonomous driving system for a vehicle. The system includes a sensor cleaning system that can be used to remove debris from one or more sensors onboard the vehicle. These sensors may be used to provide imaging data—e.g., used by the autonomous driving system to navigate and control vehicle movement. The cleaning system includes a computer that is programmed, among other things, to determine a presence of the debris and to determine whether to apply a first fluid or a second fluid. In one example, the first fluid may be a gas, and the second fluid may be a liquid.

In general, the computing systems and/or devices described may employ any of a number of computer operating systems, including, but by no means limited to, versions and/or varieties of the Ford SYNC® application, AppLink/Smart Device Link middleware, the Microsoft® Automotive operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

The processor is implemented via circuits, chips, or other electronic component and may include one or more microcontrollers, one or more field programmable gate arrays (FPGAs), one or more application specific circuits ASICs), one or more digital signal processors (DSPs), one or more customer integrated circuits, etc. The processor may be programmed to receive imaging data, control vehicle pumps, control vehicle heaters, etc. Processing the data may include processing the video feed or other data stream captured by the sensors to determine the roadway lane of the host vehicle and the presence of any target vehicles. As described below, the processor instructs vehicle components to actuate in accordance with the sensor data. The processor may be incorporated into a controller, e.g., an autonomous mode controller.

The memory (or data storage device) is implemented via circuits, chips or other electronic components and can include one or more of read only memory (ROM), random access memory (RAM), flash memory, electrically programmable memory (EPROM), electrically programmable and erasable memory (EEPROM), embedded MultiMediaCard (eMMC), a hard drive, or any volatile or non-volatile media etc. The memory may store data collected from sensors.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A computer, programmed to:
determine debris on a sensor of a vehicle;
determine an absence of an ongoing execution of a collision avoidance instruction; and
based on the determinations, apply a fluid to the sensor.

2. The computer of claim 1, wherein the computer further is programmed to apply the fluid to a window of the sensor, wherein the window comprises a cover, a lens, or a combination thereof.

3. The computer of claim 1, wherein the sensor is a camera or light detection and ranging (LIDAR) device that provides imaging data to an autonomous driving system in the vehicle.

4. The computer of claim 1, wherein the fluid is one of a gas or a liquid.

5. The computer of claim 1, wherein the computer further is programmed to apply the fluid during a predetermined time interval associated with the determined absence.

6. The computer of claim 5, wherein the predetermined time interval is less than three seconds.

7. The computer of claim 1, wherein the computer further is programmed to apply a first fluid to the sensor based on the determination of the debris, wherein, when the first fluid does not remove the debris, the computer further is programmed to apply a second fluid to the sensor based on the determination of the debris on the sensor and based on the determined absence.

8. The computer of claim 7, wherein the first fluid is compressed air, wherein the second fluid is a cleaning solution.

9. The computer of claim 1, wherein the computer further is programmed to: determine second debris on a second sensor; and determine to apply the fluid the first and second sensors sequentially based on determining that the first and second sensors are within a common zone of the vehicle.

10. The computer of claim 1, wherein the computer further is programmed to: determine that a collision avoidance instruction will not be initiated within a predetermined time interval; and based on this determination and the determination of the debris, then apply the fluid to the sensor during the interval.

11. The computer of claim 1, wherein the computer further is programmed to: determine that a rain rate parameter is less than or equal to a threshold; and based on this determination, determine to apply a first fluid to the sensor.

12. The computer of claim 11, wherein the computer further is programmed to: determine whether the debris has been removed; and when it has not been removed, then determine to apply a second fluid to the sensor.

13. A system, comprising: the computer of claim 1; and at least one pump, wherein the computer further is programmed to control the at least one pump to deliver the fluid to the sensor.

14. The system of claim 13, wherein the at least one pump has a plurality of ports, wherein the computer further is programmed to selectively actuate the plurality of ports to control delivery of the fluid to a plurality of sensors.

15. The system of claim 13, further comprising at least one sensor coupled to the computer that provides an indication of temperature, rain rate, or both.

16. A method, comprising:
determining debris on a first sensor of a vehicle;
determining an absence of an ongoing execution of a collision avoidance instruction; and
based on the determinations, applying a fluid to the first sensor.

17. The method of claim 16, wherein the first sensor is a camera or light detection and ranging (LIDAR) device that provides imaging data to an autonomous driving system in the vehicle.

18. The method of claim 16, further comprising: applying a first fluid to the first sensor based on the determination of the debris; determining that the first fluid did not remove the debris; then applying a second fluid to the first sensor based both on the determination that the first fluid did not remove the debris and the determined absence.

19. The method of claim 18, wherein the first fluid is compressed air, wherein the second fluid is a cleaning solution.

20. The method of claim 16, further comprising: determining second debris on a second sensor; and applying the fluid the first and second sensors sequentially based on determining that the first and second sensors are within a common zone of the vehicle.
